(19) United States
(12) Patent Application Publication
(10) Pub. No.: US 2019/0156677 A1
(43) Pub. Date: May 23, 2019

(54) DRIVING ASSISTANCE APPARATUS

(71) Applicant: TOYOTA JIDOSHA KABUSHIKI KAISHA, Toyota-shi (JP)

(72) Inventors: Kazuya NISHIMURA, Okazaki-shi (JP); Yoshihiro OE, Kawasaki-shi (JP)

(73) Assignee: TOYOTA JIDOSHA KABUSHIKI KAISHA, Toyota-shi (JP)

(21) Appl. No.: 16/142,701

(22) Filed: Sep. 26, 2018

(30) Foreign Application Priority Data
Nov. 20, 2017 (JP) 2017-223084

(51) Int. Cl. G08G 1/16; G08G 1/01; G08G 1/04; G01C 3/08

(52) U.S. Cl. CPC G08G 1/166; G08G 1/0112; G01C 3/08; G08G 1/163; G08G 1/04

(57) ABSTRACT

A driving assistance apparatus includes: a measurement unit configured to measure a distance to a front side position which positions front side of an obstacle in a vehicle front-rear direction of a host vehicle from the host vehicle when the host vehicle stops temporarily before an intersection in which a blind spot caused by the obstacle is present; and a vehicle controller configured to stop the host vehicle such that a distance between a front end portion of the host vehicle and the front side position satisfies a predetermined criterion based on the distance measured by the measurement unit when the host vehicle moves forward from a position at which the host vehicle temporary stops.

### INCORPORATION BY REFERENCE

The disclosure of Japanese Patent Application No. 2017-223084 filed on Nov. 20, 2017 including the specification, drawings and abstract is incorporated herein by reference in its entirety.

### BACKGROUND

### 1. Technical Field

The disclosure relates to a driving assistance apparatus.

### 2. Description of Related Art

A technology in which a point of interest of a probe car is presumed as a road environment with bad driver visibility when the probe car detects that a vehicle stops at two stages at the point of interest based on traveling data items of a plurality of vehicles has been known (for example, see Japanese Unexamined Patent Application Publication No. 2007-109001 (JP 2007-109001 A)).

### SUMMARY

When the vehicle stops at two stages at an intersection with bad driver visibility, driving assistance for further improving the convenience of a driver has been examined.

The disclosure provides a driving assistance apparatus capable of further improving the convenience of a driver when a vehicle stops at two stages at an intersection with bad driver visibility.

A first aspect of the disclosure provides a driving assistance apparatus. The driving assistance apparatus includes a measurement unit configured to measure a distance to a front side position which positions front side of an obstacle in a vehicle front-rear direction of a host vehicle from the host vehicle when the host vehicle stops temporarily before an intersection in which a blind spot caused by the obstacle is present; and a vehicle controller configured to stop the host vehicle such that a distance between a front end portion of the host vehicle and the front side position satisfies a predetermined criterion based on the distance measured by the measurement unit when the host vehicle moves forward from a position at which the host vehicle temporary stops.

According to the first aspect of the disclosure, when the host vehicle moves forward from the temporary stop position at the intersection in which the blind spot caused by the obstacle is present, the host vehicle is stopped such that the distance between the front end portion of the host vehicle and the front side position, which is a position located front side of the obstacle in the front-rear direction of the host vehicle (hereinafter, also referred to as “front side position of the obstacle), satisfies the predetermined criterion. Thus, when a vehicle stops at two stages at an intersection with bad driver visibility, it is possible to further improve the convenience of the driver.

In the driving assistance apparatus according to the first aspect of the disclosure, the vehicle controller may be configured to stop the host vehicle such that the distance between the front end portion of the host vehicle and the front side position is equal to or shorter than a predetermined distance.

In the driving assistance apparatus according to the first aspect of the disclosure, the vehicle controller may be configured to continue to stop the host vehicle until a driver performs a predetermined manipulation after the vehicle controller stops the host vehicle.

In the driving assistance apparatus according to the first aspect of the disclosure, the predetermined manipulation may be a manipulation for a brake pedal.

The driving assistance apparatus according to the first aspect of the disclosure may further include a first detection unit configured to detect the obstacle based on an image obtained by capturing a region in front of the host vehicle in a state in which the host vehicle stops temporarily at a temporary stop line on a road before the intersection. The measurement unit may be configured to measure the distance to the front side position from the host vehicle when the obstacle is detected by the first detection unit.

The driving assistance apparatus according to the first aspect of the disclosure may further include a second detection unit configured to detect the temporary stop line based on the image obtained by capturing the region in front of the host vehicle. The vehicle controller may be configured to stop the host vehicle at the temporary stop line detected by the second detection unit.

In the driving assistance apparatus according to the first aspect of the disclosure, the measurement unit may be configured to measure the distance between the front end portion of the host vehicle and the front side position as the distance to the front side position from the host vehicle.

A second aspect of the disclosure relates to a driving assistance apparatus. The driving assistance apparatus includes a camera configured to obtain an image by capturing a region in front of a host vehicle; and circuitry. The circuitry is configured to: measure a distance to a front side position which positions front side of an obstacle in a vehicle front-rear direction of the host vehicle from the host vehicle by using the image captured by the camera when the host vehicle stops temporarily before an intersection in which a blind spot caused by the obstacle is present; perform a control such that the host vehicle automatically moves forward from a position at which the host vehicle temporary stops; and stop the host vehicle moving forward from the position at which the host vehicle temporary stops such that a distance between a front end portion of the host vehicle and the front side position satisfies a predetermined criterion based on the measured distance.

In the driving assistance apparatus according to the second aspect of the disclosure, the circuitry may be configured to measure the distance between the front end portion of the host vehicle and the front side position as the distance to the front side position from the host vehicle.

According to the aspects of the disclosure, it is possible to further improve the convenience of a driver when the vehicle stops at two stages at an intersection with bad driver visibility.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram showing a configuration of a driving assistance apparatus according to an embodiment of the disclosure;

FIG. 2A is a diagram showing a situation in which a vehicle having the driving assistance apparatus of FIG. 1 mounted thereon stops at a temporary stop line;

FIG. 2B is a diagram showing a situation in which the vehicle stops at two stages;

FIG. 3 is a flowchart showing processing using the driving assistance apparatus of FIG. 1; and

FIG. 4 is a flowchart showing processing using the driving assistance apparatus of FIG. 1.

### DETAILED DESCRIPTION OF EMBODIMENTS

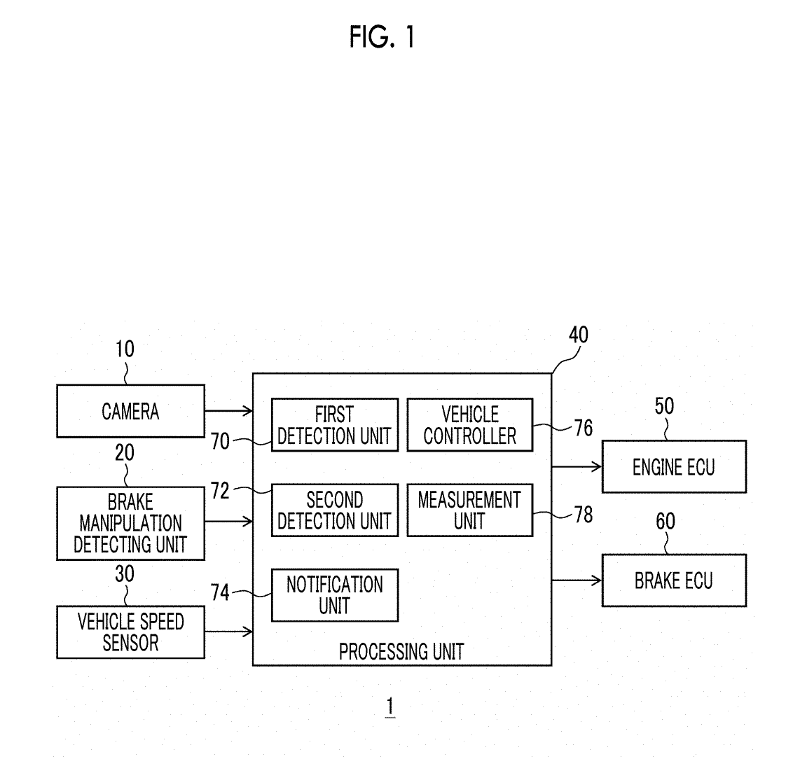

FIG. 1 is a block diagram showing a configuration of a driving assistance apparatus 1 according to an embodiment of the disclosure. The driving assistance apparatus 1 is mounted on a vehicle such as an automobile. The driving assistance apparatus 1 includes a camera 10, a brake manipulation detecting unit 20, a vehicle speed sensor 30, a processing unit 40, an engine electronic control unit (ECU) 50, and a brake ECU 60.

The camera 10 is provided in the host vehicle, and obtains an image by capturing a region in front of the host vehicle. The camera 10 outputs the captured image to the processing unit 40. The brake manipulation detecting unit 20 detects whether or not a driver steps on a brake pedal of the host vehicle, and outputs the detection result to the processing unit 40. The vehicle speed sensor 30 detects a vehicle speed of the host vehicle, and outputs the detection result to the processing unit 40.

The processing unit 40 is also called an electronic control unit. The processing unit 40 controls the two-stage stop of the host vehicle by controlling the engine ECU 50 and the brake ECU 60 based on the image captured by the camera 10 and the detection results obtained from the brake manipulation detecting unit 20 and the vehicle speed sensor 30.

The engine ECU 50 controls the driving force of the host vehicle by controlling a throttle opening degree of the engine according to a control signal from the processing unit 40 during the control of the two-stage stop. The engine ECU 50 also controls the throttle opening degree according to a manipulation amount of an accelerator pedal. The brake ECU 60 activates the brake of the host vehicle according to a control signal from the processing unit 40 during the control of the two-step stop. The brake ECU 60 controls the brake according to a manipulation amount of the brake pedal.

The processing unit 40 includes a first detection unit 70, a second detection unit 72, a notification unit 74, a vehicle controller 76, and a measurement unit 78. The second detection unit 72 detects a temporary stop line on a road before an intersection through image recognition based on the image obtained by capturing the region in front of the host vehicle by using the camera 10. When a temporary stop sign before the intersection is detected through the image recognition, the second detection unit 72 detects a line on the road near the sign as the temporary stop line.

When the vehicle speed detected by the vehicle speed sensor 30 at the time when the second detection unit 72 detects the temporary stop line is higher than a predetermined possible-to-stop speed, the notification unit 74 notifies the driver that the host vehicle will automatically stop through voice or screen display. For example, the notification unit 74 announces that the host vehicle will stop through a voice announcing, for example, “Vehicle will stop.” The possible-to-stop speed may be appropriately determined through tests. In this case, there is a possibility that the driver will overlook the temporary stop line or there is a possibility that the driver will have no intention of stopping the host vehicle even though the driver is aware of the temporary stop line.

The vehicle controller 76 controls the traveling of the host vehicle by controlling the engine ECU 50 and the brake ECU 60. When the vehicle speed at the time when the second detection unit 72 detects the temporary stop line is higher than the possible-to-stop speed, the vehicle controller 76 performs deceleration control and operates an automatic brake after the notification using the notification unit 74 is performed. The vehicle controller 76 stops the host vehicle near the detected temporary stop line.

When the vehicle speed at the time when the second detection unit 72 detects the temporary stop line is equal to or lower than the predetermined possible-to-stop speed, the vehicle controller 76 does not operate the automatic brake without performing the deceleration control. In this case, it is possible to expect that the driver has the intention of stopping the host vehicle. In this case, when the host vehicle does not stop even after a predetermined time elapses from when the second detection unit 72 detects the temporary stop line, the vehicle controller 76 may operate the automatic brake.

The first detection unit 70 detects an obstacle through the image recognition based on an image obtained by capturing a region in front of the host vehicle in a state in which the host vehicle stops temporarily at the temporary stop line. For example, when an obstacle having a predetermined height or more is present in front of a road crossing a traveling direction of the host vehicle, the first detection unit 70 detects the obstacle as an obstacle. The predetermined height may be appropriately determined through tests.

When the obstacle is detected by the first detection unit 70, the measurement unit 78 measures a distance to a front side position of the obstacle from the host vehicle through the image recognition of the captured image. The aforementioned configuration is an example in which the measurement unit 78 measures the distance to the front side position of the obstacle from the host vehicle when the host vehicle stops temporarily before the intersection in which a blind spot caused by the obstacle is present. Specifically, the measurement unit 78 measures the distance to the front side position of the obstacle from a front end portion of the host vehicle with consideration for a distance to the front end portion of the host vehicle from the camera 10. The known technique may be used in the aforementioned distance measurement. In the present embodiment, the “front side position of the obstacle” may be regarded as a position corresponding to the front end portion of the obstacle in a vehicle front-rear direction. The measurement unit 78 does not measure the distance when the obstacle is not detected by the first detection unit 70. In this case, the subsequent two-stage control is not performed.

When the measurement unit 78 measures the distance, the notification unit 74 notifies the driver that the host vehicle will start to move through the voice or the screen display. For example, the notification unit 74 announces that the host vehicle will start to move through a voice announcing such as “Vehicle will move forward. Please take your foot off brake pedal.”

The vehicle controller 76 cancels the automatic brake when the automatic brake is operated. When the driver does not step on the brake pedal, the vehicle controller 76 performs a control such that the host vehicle moves forward at a low speed. When the driver steps on the brake pedal, the vehicle controller 76 waits until the driver takes his or her foot off the brake pedal.

When the host vehicle moves forward from the temporary stop position, the vehicle controller 76 stops the host vehicle by operating the automatic brake such that the distance between the front end portion of the host vehicle and the front side position of the obstacle satisfies a predetermined criterion based on the distance measured by the measurement unit 78 and a traveling distance to which the host vehicle travels from the temporary stop position. Specifically, the vehicle controller 76 stops the host vehicle such that the distance between the front end portion of the host vehicle and the front side position of the obstacle is equal to or shorter than a predetermined distance. The predetermined distance may be appropriately determined through tests. The distance between the front end portion of the host vehicle and the front side position of the obstacle being equal to or shorter than the predetermined distance means that the front end portion of the host vehicle does not protrude forward from the front side position of the obstacle.

When the vehicle controller 76 stops the host vehicle, the notification unit 74 notifies the driver that the host vehicle will stop moving through voice or screen display. For example, the notification unit 74 announces that the host vehicle will stop moving through a voice announcing, for example, “Vehicle will stop moving. Please step on brake pedal.”

After the vehicle controller stops the host vehicle moving forward from the temporary stop position, the vehicle controller 76 continues to stop the host vehicle by operating the automatic brake until the driver performs a predetermined manipulation. That is, after the vehicle controller stops the host vehicle moving forward from the temporary stop position, the vehicle controller 76 cancels the automatic brake when the driver performs the predetermined manipulation.

The predetermined manipulation is, for example, a manipulation for the brake pedal. The automatic brake is operated until the driver performs a manipulation for stepping on the brake pedal. Thus, the vehicle does not move forward even though the driver steps on the accelerator pedal. When the driver performs the manipulation for stepping on the brake pedal, the driver can drive the vehicle.

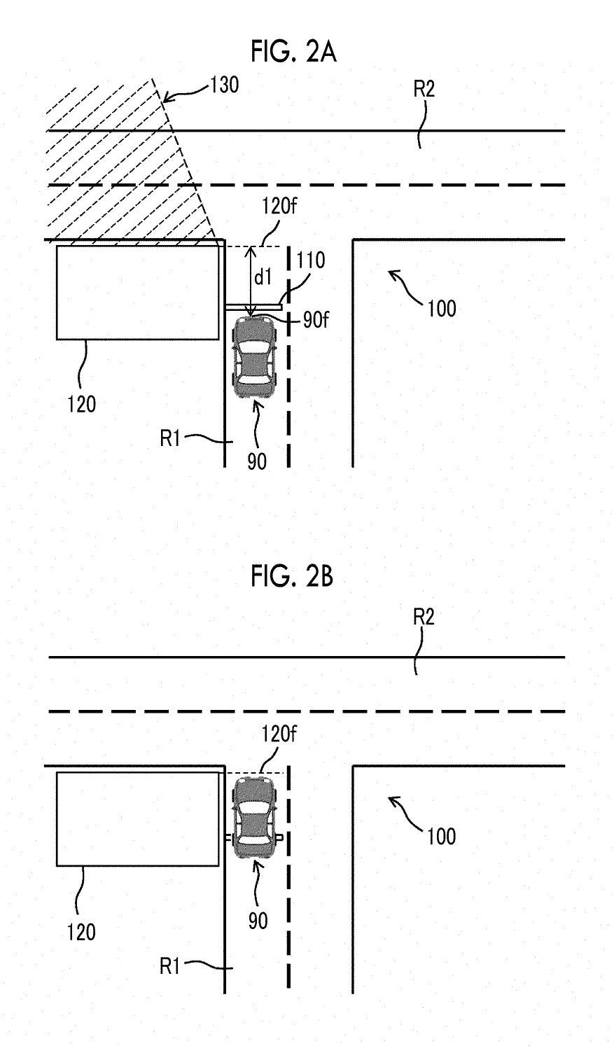

FIG. 2A is a diagram showing a situation in which a vehicle 90 having the driving assistance apparatus 1 of FIG. 1 mounted thereon stops at a temporary stop line 110. FIG. 2B is a diagram showing a situation in which the vehicle 90 stops at two stages. As shown in FIG. 2A, the vehicle 90 stops at the temporary stop line 110 on a road R1 toward an intersection 100. The road R1 intersects a road R2 that extends in a right-left direction of the vehicle 90 in the intersection 100. That is, the intersection 100 is a T-shaped road. An obstacle 120 that results in a blind spot 130 is present near the left side of the temporary stop line 110. The obstacle 120 is positioned higher than the eyes of a driver of the vehicle 90, and the blind spot 130 is present near the road R2 on the left side in front of the vehicle 90. That is, the driver of the vehicle 90 stopped at the temporary stop line 110 is not able to view the range of the blind spot 130 of the road R2.

As stated above, the measurement unit measures a distance dl to a front side position 120f of the obstacle 120 from a front end portion 90f of the vehicle 90. The vehicle 90 automatically moves forward from the position of FIG. 2A under the control of the vehicle controller 76. Thereafter, the vehicle stops automatically such that the distance between the front end portion of the vehicle 90 and the front side position 120f of the obstacle 120 is equal to or shorter than the predetermined distance as shown in FIG. 2B.

In this state, when the driver performs the manipulation for stepping on the brake pedal as stated above, the control of the vehicle controller 76 is ended, and thus, the driver can drive the vehicle 90. The blind spot in the situation of FIG. 2B is further reduced than that in the situation of FIG. 2A. The driver drives slowly while taking his or her foot off the brake pedal, enters the intersection 100 while looking right and left, and turns right or left.

A hardware configuration of the processing unit 40 may be realized by a central processing unit (CPU), a memory, or large-scale integration (LSI) of any computer. The hardware configuration is realized by a program loaded into the memory. A functional block realized by the cooperation of hardware with software is shown. Accordingly, it should be understood by those skilled in the art that the function block may be realized in various forms by using solely hardware, solely software, or the combination of hardware and software.

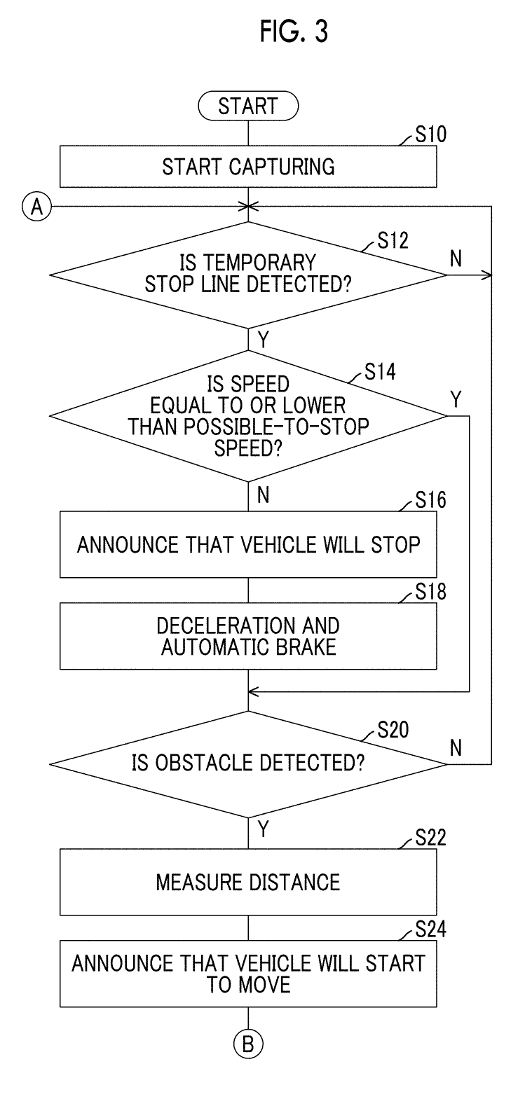

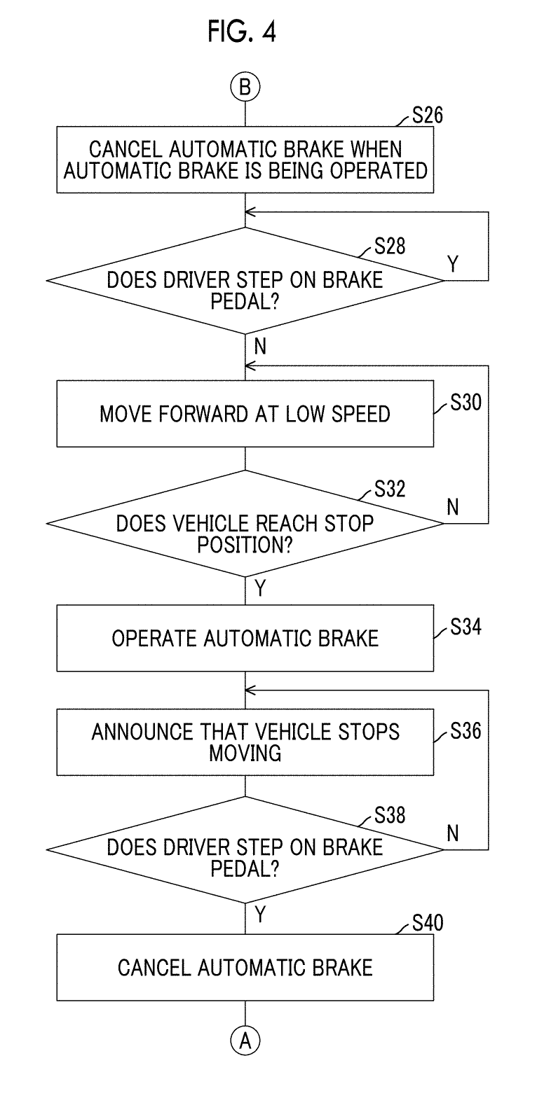

The overall operation of the driving assistance apparatus 1 having the aforementioned configuration will be described. FIGS. 3 and 4 are flowcharts showing processing using the driving assistance apparatus 1 of FIG. 1. For example, the processing is started when an ignition switch of the host vehicle is turned on, and is ended when the ignition switch is turned off.

As shown in FIG. 3, the camera 10 starts capturing (S10). When the second detection unit 72 does not detect the temporary stop line (N of S12), the vehicle controller waits in step S12. When the second detection unit 72 detects the temporary stop line (Y of S12) and the vehicle speed is equal to or lower than the possible-to-stop speed (Y of S14), the vehicle controller proceeds to step S20 to be described below. When the vehicle speed is higher than the possible-to-stop speed (N of S14), the notification unit 74 announces that the vehicle will stop (S16). The vehicle controller 76 performs the deceleration control, and operates the automatic brake (S18).

When the first detection unit 70 does not detect the obstacle based on the image captured in a state in which the host vehicle stops temporarily at the temporary stop line (N of S20), the vehicle controller proceeds to step S12. When the first detection unit 70 detects the obstacle (Y of S20), the measurement unit 78 measures the distance to the front side position of the obstacle from the front end portion of the host vehicle (S22). The notification unit 74 announces that the host vehicle will start to move (S24).

Referring to FIG. 4, the vehicle controller 76 cancels the automatic brake when the automatic brake is operated (S26). When the driver steps on the brake pedal (Y of S28), the vehicle controller waits in step S28. When the driver does not step on the brake pedal (N of S28), the vehicle controller 76 moves the host vehicle forward at a low speed (S30). When the host vehicle does not reach a stop position (N of S32), the vehicle controller returns to step S30. The stop position is a position in which the distance between the front end portion of the host vehicle and the front side position of the obstacle is equal to or shorter than the predetermined distance. When the host vehicle reaches the stop position (Y of S32), the vehicle controller 76 stops the host vehicle by operating the automatic brake (S34). The notification unit 74 announces the host vehicle will stop moving (S36). When the driver does not step on the brake pedal (N of S38), the vehicle controller returns to step S36. When the driver steps on the brake pedal (Y of S38), the vehicle controller 76 cancels the automatic brake (S40), and returns to step S12.

As stated above, according to the embodiment of the disclosure, when the host vehicle moves forward from the temporary stop position in the intersection in which the blind spot caused by the obstacle is present, the host vehicle is stopped such that the distance between the front end portion of the host vehicle and the front side position of the obstacle satisfies the predetermined criterion. Thus, when the vehicle stops at two stages at an intersection with bad driver visibility, it is possible to further improve the convenience of the driver.

The host vehicle is stopped such that the distance between the front end portion of the host vehicle and the front side position of the obstacle is equal to or shorter than the predetermined distance. Thus, it is possible to stop the host vehicle in a position in which the front end portion of the host vehicle is present in front of the front side position of the obstacle.

The vehicle controller 76 stops the host vehicle, and then continues to stop the host vehicle until the driver performs the predetermined manipulation. Thus, timing when the control of the two-stage stop is ended, that is, timing when the driver is to perform a driving manipulation may be determined by the driver. Accordingly, it is possible to further improve safety. The predetermined manipulation is a manipulation for the brake pedal, it is possible to restrain the host vehicle from moving forward when the vehicle controller 76 cancels the automatic brake. Accordingly, it is possible to further improve safety.

The first detection unit 70 detects the obstacle based on the image obtained by capturing the region in front of the host vehicle in a state in which the host vehicle temporarily stops at the temporary stop line on the road before the intersection. When the obstacle is detected, the measurement unit 78 measures the distance to the front side position of the obstacle from the host vehicle. Thus, it is possible to specify the intersection in which the blind spot caused by the obstacle is present, and it is possible to control the two-stage stop at the specified intersection.

The second detection unit 72 detects the temporary stop line based on the image obtained by capturing the region in front of the host vehicle. The vehicle controller 76 stops the host vehicle at the detected temporary stop line. Thus, it is possible to reliably temporarily stop the host vehicle before the intersection.

When a temporary stop sign before the intersection is detected through the image recognition, the second detection unit 72 detects a line on the road near the sign as the temporary stop line. Thus, it is possible to further improve the detection accuracy of the temporary stop line.

The embodiment has been described above. The embodiment is merely an example. It should be understood by those skilled in the art that the combinations of the components or the processing processes may be modified in various manners and these modification examples may be included in the scope of the disclosure.

For example, a navigation device may store the position of the temporary stop line. When the current position of the host vehicle approaches the position of the stored temporary stop line, the second detection unit 72 may start the image recognition of the temporary stop line. In the modification example, it is possible to further improve the detection accuracy of the temporary stop line.

Information regarding the intersection in which the blind spot caused by the obstacle is present may be stored in the navigation device (not shown) in advance. A server device (not shown) may specify the intersection in which the blind spot caused by the obstacle is present based on big data collected from a plurality of vehicles, and may transmit the information to each vehicle. The intersection includes an intersection having no temporary stop line. In the modification example, when the host vehicle stops temporarily before the intersection in which the blind spot caused by the obstacle is present, the measurement unit 78 measures the distance to the front side position of the obstacle from the vehicle. The subsequent processing processes are the same as those in the embodiment. According to the modification example, it is possible to cope with an intersection in which there is no temporary stop line and there is the blind spot.

In the modification example, when the host vehicle approaches the intersection in which the blind spot caused by the obstacle is present, the notification unit 74 may announce a warning based on the positional information of the host vehicle. As mentioned above, the driver can recognize that the intersection is an intersection with bad driver visibility in advance. When the host vehicle does not temporarily stop before the intersection, the vehicle controller 76 may operate the automatic brake. As described above, it is possible to further improve safety.

It has been described that the measurement unit 78 measures the distance based on the image recognition result. However, the disclosure is not particularly limited, and the measurement unit may measure the distance by using, for example, a millimeter wave radar, a laser radar, a stereo camera, or an ultrasonic sensor.

The vehicle may be a hybrid vehicle or may be an electric vehicle.

What is claimed is:

1. A driving assistance apparatus comprising:
a measurement unit configured to measure a distance to a front side position which positions front side of an obstacle in a vehicle front-rear direction of a host vehicle from the host vehicle when the host vehicle stops temporarily before an intersection in which a blind spot caused by the obstacle is present; and
a vehicle controller configured to stop the host vehicle such that a distance between a front end portion of the host vehicle and the front side position satisfies a predetermined criterion based on the distance measured by the measurement unit when the host vehicle moves forward from a position at which the host vehicle temporary stops.

2. The driving assistance apparatus according to claim 1, wherein
the vehicle controller is configured to stop the host vehicle such that the distance between the front end portion of the host vehicle and the front side position is equal to or shorter than a predetermined distance.

3. The driving assistance apparatus according to claim 1, wherein
the vehicle controller is configured to continue to stop the host vehicle until a driver performs a predetermined manipulation after the vehicle controller stops the host vehicle.

4. The driving assistance apparatus according to claim 3, wherein
the predetermined manipulation is a manipulation for a brake pedal.

5. The driving assistance apparatus according to claim 1, further comprising
a first detection unit configured to detect the obstacle based on an image obtained by capturing a region in front of the host vehicle in a state in which the host vehicle stops temporarily at a temporary stop line on a road before the intersection,
wherein the measurement unit is configured to measure the distance to the front side position from the host vehicle when the obstacle is detected by the first detection unit.

6. The driving assistance apparatus according to claim 5, further comprising
a second detection unit configured to detect the temporary stop line based on the image obtained by capturing the region in front of the host vehicle,
wherein the vehicle controller is configured to stop the host vehicle at the temporary stop line detected by the second detection unit.

7. The driving assistance apparatus according to claim 1, wherein
the measurement unit is configured to measure the distance between the front end portion of the host vehicle and the front side position as the distance to the front side position from the host vehicle.

8. A driving assistance apparatus comprising:
a camera configured to obtain an image by capturing a region in front of a host vehicle; and
circuitry configured to
measure a distance to a front side position which positions front side of an obstacle in a vehicle front-rear direction of the host vehicle from the host vehicle by using the image captured by the camera when the host vehicle stops temporarily before an intersection in which a blind spot caused by the obstacle is present,
perform a control such that the host vehicle automatically moves forward from a position at which the host vehicle temporary stops, and
stop the host vehicle moving forward from the position at which the host vehicle temporary stops such that a distance between a front end portion of the host vehicle and the front side position satisfies a predetermined criterion based on the measured distance.

9. The driving assistance apparatus according to claim 8, wherein
the circuitry is configured to measure the distance between the front end portion of the host vehicle and the front side position as the distance to the front side position from the host vehicle.
